(19) United States
(12) Patent Application Publication
(10) Pub. No.: US 2020/0001931 A1
(43) Pub. Date: Jan. 2, 2020

(54) Protective Barrier on a Wheelhouse Liner

(71) Applicant: GM GLOBAL TECHNOLOGY OPERATIONS LLC, Detroit, MI (US)

(72) Inventors: David M. Connor, Armada, MI (US); Douglas L. Wickham, Troy, MI (US); David R. Cowger, Fenton, MI (US)

(21) Appl. No.: 16/020,135

(22) Filed: Jun. 27, 2018

(51) Int. Cl. B62D 25/18; B62D 29/04; B32B 1/00; B32B 27/12; B32B 27/40

(52) U.S. Cl. CPC B62D 25/18; B62D 29/04; B32B 1/00; B32B 27/12; B32B 2605/00; B32B 2262/0269; B32B 2262/0246; B32B 2571/02; B32B 27/40

(57) ABSTRACT

A protective barrier for fortifying a portion of a vehicle wheel house liner includes the wheel house liner having an arching shaped molded main body with opposing ends configured for providing a barrier between a tire and a wheel house cavity. A ballistics material patch is integrally molded with a predetermined portion of the molded main body and is configured to provide a protective barrier between the tire and a vehicle body structure.

### FIELD

The present disclosure relates to vehicle wheel house liners and more particularly to a protective barrier disposed on a wheel house liner.

### BACKGROUND

It is known in the art to line the outer wheel arch of vehicles with a trim part or cladding, also known as outer wheel arch liner, fender liner or wheel outer liner. These wheel arch liners can be mounted on the front and/or rear wheel arch opposite the wheel to protect the body of the car.

These wheel arch liners may reduce the noise transmission into the vehicle interior of noises generated during driving of the vehicle. These noises are mainly caused by the wheel rotating on the road surface, as well as noise from coming from water and stones thrown by the tires at the wheel house. However the wheel arch liner also serves as protection against particles highly accelerated against the wheel arch during driving, due to the rotating wheel, such as sand and gravel, and for protection against water and mud.

Wheel arch liners are formed to follow the shape of the wheel housing of vehicles. Wheel arch liners are therefore formed as 3-dimensional semi-circular structural parts. The physical properties such as structural stiffness and durability of wheel arch liners can be important for providing protection to components in (e.g., tires) or B surfaces of components forming the wheel house of the vehicle.

In the absence of wheel arch liners such components can be subjected to stone pelting, dirt, road debris, hot, cold and/or wet weather conditions and might also collide with obstacles underneath the car during use. For example, in some cases due to architectural space restraints a vehicle tire may have minimal clearance to prevent contacting an unfriendly interface (e.g., vehicle structure) due to exceeding tire flop limits, particularly when subjected to certain road hazards such as potholes. Such contact can cause damage to a tire or the vehicle structure if proper protection is not provided.

### SUMMARY

One or more exemplary embodiments address the above issue by providing a protective barrier disposed on a wheel house liner. More particularly, a protective barrier disposed on a wheel house liner and a method of manufacturing the same. In accordance with aspects of an exemplary embodiment, a protective barrier for fortifying a portion of a vehicle wheel house liner includes the wheel house liner having an arching shaped molded main body with opposing ends configured for providing a barrier between a tire and a wheel house cavity, wherein the wheel house liner includes a vehicle structure contact side. And another aspect in accordance with the exemplary embodiment includes a ballistics material patch integrally molded with a predetermined portion of the molded main body configured to provide a protective barrier between the tire and a vehicle structure. And still another aspect wherein the predetermined portion of the molded main body is at least one of the opposing ends on the vehicle structure contact side of the wheel house liner. And yet another aspect wherein the ballistics material patch is formed of an oxidized polyacrylonitrile fiber material and binding fibers.

Further aspects are disclosed as exemplary embodiments wherein the ballistics material patch is formed of a para aramid fiber material and binding fibers, or wherein the ballistics material patch further includes a middle layer formed of thermal plastic polyurethane foil material between two layers of oxidized polyacrylonitrile fiber material and binding fibers. And another embodiment wherein the ballistics material patch further includes a middle layer formed of thermal plastic polyurethane foil material between two layers of para aramid fiber material and binding fibers. Still other embodiments wherein the ballistics material patch further includes a reinforcing layer formed of thermal plastic polyurethane foil material disposed on the vehicle structure contact side of the wheel house liner. And another aspect wherein the vehicle structure is the hinge pillar pinch weld flange.

A method of manufacturing a wheel house line disposed with a protective barrier includes adhering a ballistic material patch to a predetermined portion of a wheel house liner material blank; heat molding the wheel house liner material blank and the adhered ballistic material patch together to form a wheel house liner having an arching shaped main body with opposing ends, wherein the wheel house liner is configured for providing a barrier between a tire and a wheel house cavity, and wherein the wheel house liner includes a vehicle structure contact side; and removing the molded wheel house liner and ballistic material patch from the mold wherein the ballistic material patch is configured to provide a protective barrier between the tire and a vehicle structure.

### BRIEF DESCRIPTION OF THE DRAWINGS

The present exemplary embodiment will be better understood from the description as set forth hereinafter, with reference to the accompanying drawings, in which:

FIG. 1 is an illustration of a vehicle wheel house.

FIG. 2 is an example of a wheel house liner in physical contact with a vehicle structure.

FIG. 3 is an illustration of a wheel house liner having a ballistics material patch disposed on a vehicle structure contact side in accordance with aspects of an exemplary embodiment.

FIG. 4 is an illustration of the wheel house liner of FIG. 3 in physical contact with the vehicle structure of FIG. 2 in accordance with aspects of the exemplary embodiment.

FIGS. 5A & 5B are illustrations of exemplary embodiments of ballistics material patches.

FIG. 6 is an illustration of a method of manufacturing the protective barrier on a wheel house liner in accordance with aspects of the exemplary embodiment.

FIG. 7 is an illustration of an algorithm for performing the method of FIG. 6 in accordance with aspects of the exemplary embodiment.

### DETAILED DESCRIPTION OF THE INVENTION

The following description is merely exemplary in nature and is not intended to limit the present disclosure, application, or uses thereof.

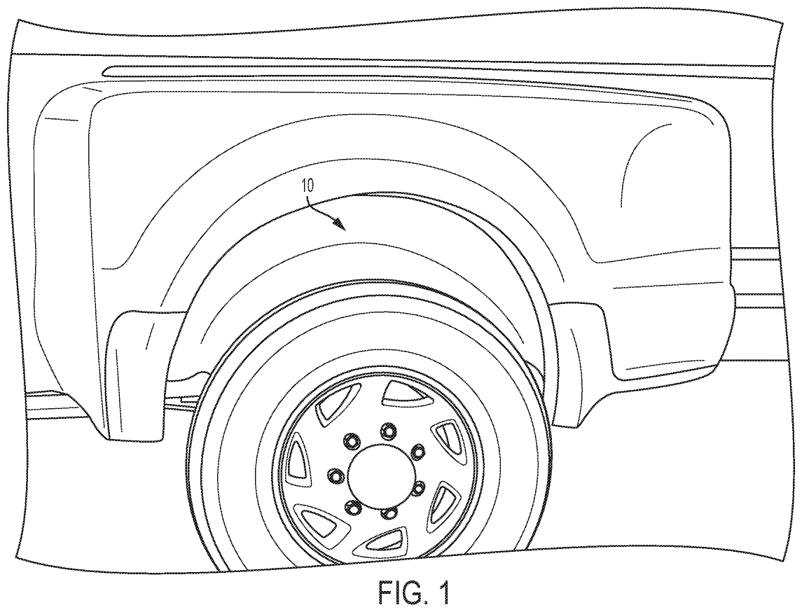

FIG. 1 provides an illustration of a vehicle wheel house 10 which is essentially the underside of a vehicle's fender. The primary purpose of the wheel house 10 is to prevent sand, mud, rocks, liquids, and other road spray from being thrown into the air by the rotating tire. To protect the underside of the vehicle fenders and other underside surfaces a wheel house liner is disposed between the vehicle tires and wheel house cavity.

In addition to serving as a barrier against projectiles caused by the rotating wheels, the wheel house liner may serve additional functions, including acoustic and aesthetic. Furthermore, the wheel house liner may block some of the more unsightly components and/or structure of the vehicle from being seen from the exterior of the vehicle. Some wheel house liners have an exterior edge exposed. Other vehicles include an additional molding to cover the edge such that it is not visible.

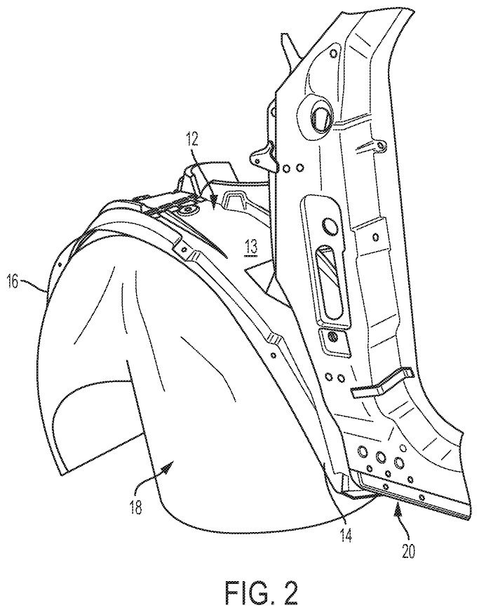

Referring now to FIG. 2, a wheel house liner 12 generally is shaped to match that of the wheel house 10. In this case, the wheel house liner 12 has an arched shaped molded main body with opposing ends (14, 16) which is configured for providing a barrier between a tire and a wheel house cavity. The wheel house liner 12 includes a vehicle structure contact side 13 that may abut portions of the vehicle body such as a body hinge pillar pinch weld flange 20. A wheel envelope 18 illustrates all positions a tire may be expected to occupy during driving.

This will take into account the maximum jounce and rebound allowed by the suspension system and the maximum turn and tilt allowed by the steering mechanism. This envelope 18 is compared with the wheel house 10 and other components in the area, such as the body hinge pillar or fender perimeter, to perform an interference/collision analysis. The results of this analysis can be indicative as to whether that vehicle tire will strike the housing and components under driving conditions. In some cases due to design space restraints, a tire may have minimal clearance to prevent contacting an unfriendly interface (e.g., vehicle structure) due to exceeding tire envelope limits, particularly when subjected to certain road hazards such as speed bumps and potholes. Such contact can cause damage to the vehicle tire or the vehicle structure if proper protection is not provided.

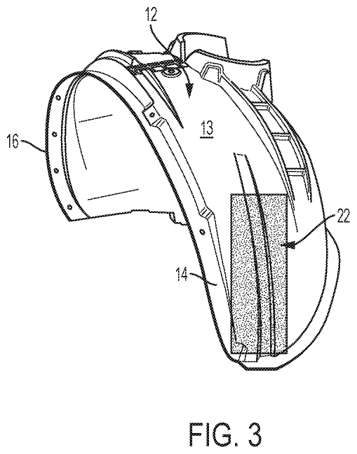

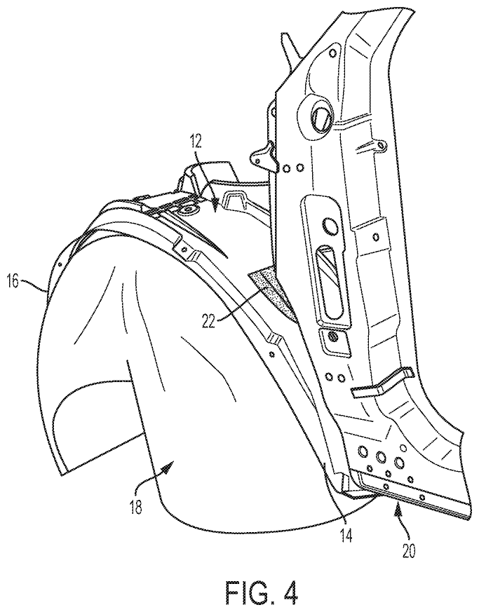

FIG. 3 illustrates a wheel house liner 12 having a ballistics material patch 22 disposed on its vehicle structure contact side 13 in accordance with aspects of an exemplary embodiment. The ballistics material patch 22 is integrally molded with a predetermined portion, e.g., at least one opposing end (14, 16) or up to the entire vehicle structure contact side 13, of the molded main body of the wheel house liner 12. The ballistics material patch 22 is configured to provide a protective barrier between the tire and a vehicle structure when the tire envelope limits are exceeded. FIG. 4 illustrates the wheel house liner 12 of FIG. 3 in physical contact with the vehicle structure 20 of FIG. 2 in accordance with aspects of the exemplary embodiment. In this case, the ballistics material patch 22 would operate to fortify the vehicle structure contact side 13 of the wheel house liner 12 such that if the vehicle tire exceeds the envelope limits in this region then tire damage can be prevented.

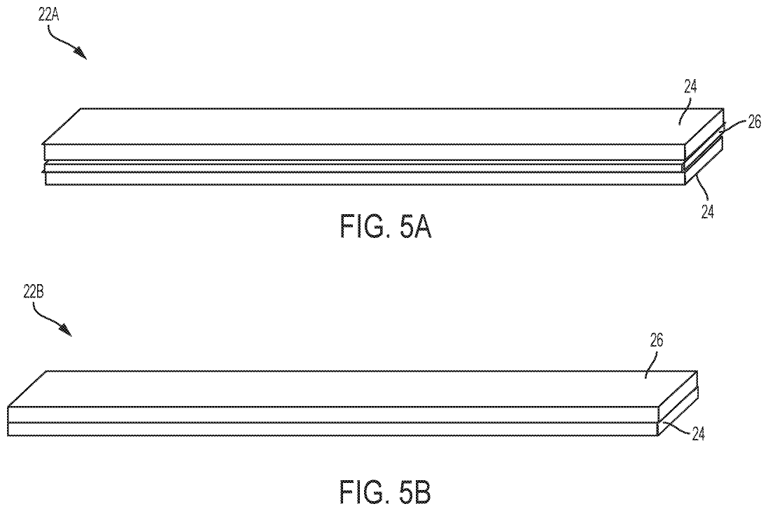

Referring now to FIGS. 5A and 5B, illustrations of exemplary embodiments of ballistics material patches (22A, 22B) are provided. The ballistics material patch 22 may be formed of several materials designed for maximum durability, heat resistance, abrasion resistance, and penetration resistance such as Kevlar®. Preferred materials include, but not limited to, illustrations of exemplary embodiments of ballistics material patches with binding fibers, a para aramid fiber material and binding fibers, and a glass fiber woven material with binding fibers. The binding fibers in accordance with aspects of the exemplary embodiment are preferably polypropylene fibers which exhibit a lower melting point than the mold material, e.g., polyethylene terephthalate.

FIG. 5A illustrates a configuration for a ballistics material patch 22A in accordance with aspects of exemplary embodiments wherein the ballistics material patch 22A includes a middle layer formed of thermal plastic polyurethane foil material 26 between two layers of ballistics material 24. The layers may be bonded together using binding fibers, resins, and adhesives suitable for such purpose. FIG. 5B illustrates an alternative configuration for a ballistics material patch 22B wherein the ballistics material patch includes a reinforcing layer formed of thermal plastic polyurethane foil material 26 disposed on the vehicle structure contact side 13 of the wheel house liner 12. Likewise, the reinforcing layer 26 may be bond with ballistics material 24 using binding fibers, resins, and adhesives suitable for such purpose.

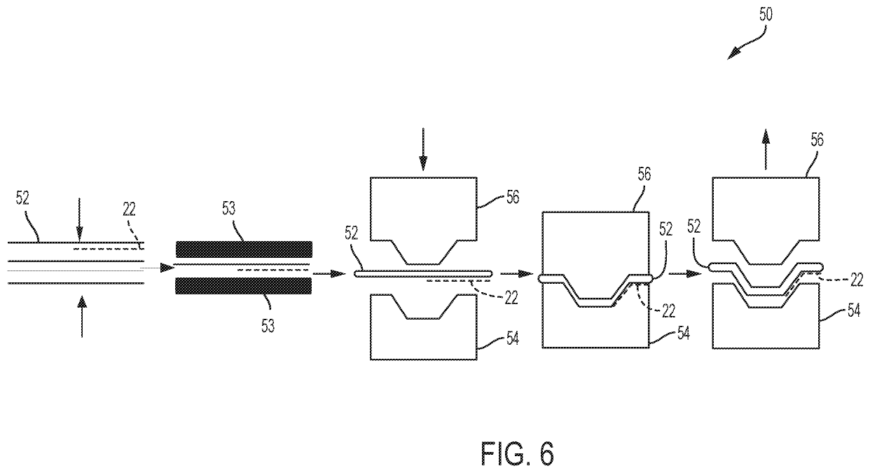

FIG. 6 provides an illustration of a method 50 of manufacturing the ballistics material patch 22 on a wheel house liner 52 in accordance with aspects of the exemplary embodiment. Generally, the method includes pre-applying the ballistics material patch 22 to a predetermined portion of a wheel house liner blank 52 and then pre-heating with heating elements 53 before placing the workpiece in a hot press mold apparatus.

Next, the workpiece is placed between the lower 54 and upper 56 molds of the hot press molding apparatus. Then, the upper mold 56 is moved down so that the workpiece is clamped between the core of the upper mold 56 and the cavity of the lower mold 54. In this state, heating is conducted while pressure is applied to the wheel house liner blank 52 and the ballistics material patch 22 such that melting occurs to bind the articles together between by the upper 16 and lower molds 14. After the articles are bonded and a cooling process is completed, the wheel house liner disposed with the ballistics material patch 22 is removed from the molding apparatus.

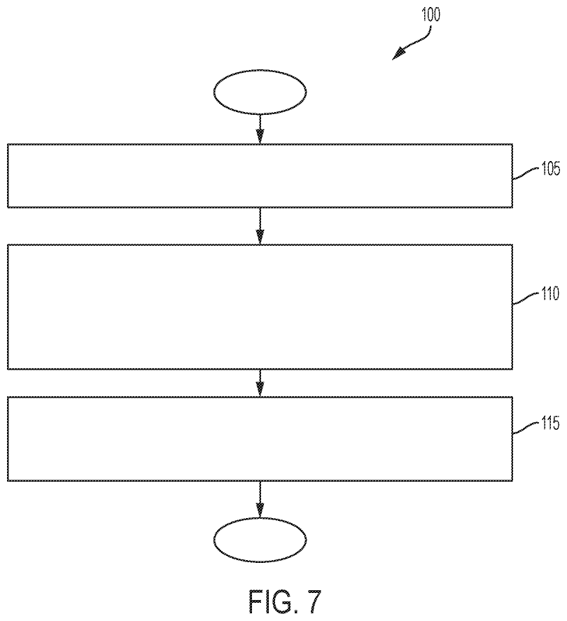

FIG. 7 is an illustration of an algorithm 100 for performing the method of FIG. 6 in accordance with aspects of the exemplary embodiment. The method begins at 105 with adhering a ballistics material patch to a predetermined portion of a wheel house liner material blank and pre-heating the workpiece prior to placing in the mold apparatus. Next, at block 110, the method continues with heat molding the wheel house liner material blank and the adhered ballistics material patch together to form a wheel house liner having an arching shaped main body with opposing ends, wherein the wheel house liner is configured for providing a barrier between a tire and a wheel house cavity, and wherein the wheel house liner includes a vehicle structure contact side. Finally, the method ends at block 115 with removing the molded wheel house liner and ballistics material patch from the mold wherein the ballistics material patch is configured to provide a protective barrier between the tire and a vehicle structure. An alternative method for manufacturing may be to place a ballistics material patch into an injection molding apparatus and then injecting molten wheel house liner material into a mold. After the molten wheel house liner material cools and hardens the wheel house liner with the integrated ballistics material patch can be removed from the injection mold apparatus.

The description of the invention is merely exemplary in nature and variations that do not depart from the gist of the invention are intended to be within the scope of the invention. Such variations are not to be regarded as a departure from the spirit and scope of the invention.

What is claimed is:

1. A protective barrier for fortifying a portion of a vehicle wheel house liner comprising:
the wheel house liner having an arching shaped molded main body with opposing ends configured for providing a barrier between a tire and a wheel house cavity, wherein the wheel house liner includes a vehicle structure contact side; and
a ballistics material patch integrally molded with a predetermined portion of the molded main body configured to provide a protective barrier between the tire and a vehicle structure.

2. The protective barrier of claim 1 wherein the predetermined portion of the molded main body is at least one of the opposing ends on the vehicle structure contact side of the wheel house liner.

3. The protective barrier of claim 1 wherein the ballistics material patch is formed of an oxidized polyacrylonitrile fiber material and binding fibers.

4. The protective barrier of claim 1 wherein the ballistics material patch is formed of a para aramid fiber material and binding fibers.

5. The protective barrier of claim 3 wherein the ballistics material patch further comprises a middle layer formed of thermal plastic polyurethane foil material between two layers of oxidized polyacrylonitrile fiber material and binding fibers.

6. The protective barrier of claim 4 wherein the ballistics material patch further comprises a middle layer formed of thermal plastic polyurethane foil material between two layers of para aramid fiber material and binding fibers.

7. The protective barrier of claim 3 wherein the ballistics material patch further comprises a reinforcing layer formed of thermal plastic polyurethane foil material disposed on the vehicle structure contact side of the wheel house liner.

8. The protective barrier of claim 4 wherein the ballistics material patch further comprises a reinforcing layer formed of thermal plastic polyurethane foil material disposed on the vehicle structure contact side of the wheel house liner.

9. The protective barrier of claim 1 wherein the vehicle structure is the hinge pillar hinge weld flange.

10. A method of fortifying a portion of a wheel house with a protective barrier comprising:
adhering a ballistics material patch to a predetermined portion of a wheel house liner material blank;
heat molding the wheel house liner material blank and the adhered ballistics material patch together to form a wheel house liner having an arching shaped main body with opposing ends, wherein the wheel house liner is configured for providing a barrier between a tire and a wheel house cavity, and wherein the wheel house liner includes a vehicle structure contact side; and
removing the molded wheel house liner and ballistics material patch from the mold wherein the ballistic material patch is configured to provide a protective barrier between the tire and a vehicle structure.

11. The method of claim 10 further comprises molding the ballistics material patch on at least one of the opposing ends on the vehicle structure contact side of the wheel house liner.

12. The method of claim 10 further comprises forming the ballistics material patch of an oxidized polyacrylonitrile fiber material and binding fibers.

13. The method of claim 10 further comprises forming the ballistics material patch of a para aramid fiber material and binding fibers.

14. The method of claim 12 further comprises forming the ballistics material patch with a middle layer of thermal plastic polyurethane foil material between two layers of oxidized polyacrylonitrile fiber material and binding fibers.

15. The method of claim 13 further comprises forming the ballistics material patch with a middle layer of thermal plastic polyurethane foil material between two layers of para aramid fiber material and binding fibers.

16. The method of claim 12 further comprises forming the ballistics material patch with a reinforcing layer of thermal plastic polyurethane foil material disposed on the vehicle structure contact side of the wheel house liner.

17. The method of claim 13 further comprises forming the ballistics material patch with a reinforcing layer of thermal plastic polyurethane foil material disposed on the vehicle structure contact side of the wheel house liner.
